(19) United States
(12) Patent Application Publication
(10) Pub. No.: US 2002/0095963 A1
(43) Pub. Date: Jul. 25, 2002

(54) Electronic deadbolt flex assembly

(76) Inventor: Alan Doerr, Tomball, TX (US)

Correspondence Address: MICHAEL BEST & FRIEDRICH LLP, 3773 CORPORATE PARKWAY, SUITE 360, CENTER VALLEY, PA, 18034-8217, US

(21) Appl. No.: 09/766,152

(22) Filed: Jan. 19, 2001

(51) Int. Cl. E05B 49/00

(52) U.S. Cl. 70/278.3; 70/278.7

(57) ABSTRACT

The invention is directed to an electronic deadbolt flex assembly for transfer of data to and from a microprocessor associated with the electronic lock assembly. The flex assembly comprises an electrical connector coupled to a solenoid assembly for operating the electronic lock. A contact spring electrically couples a data pin positioned within the cylinder plug of the lock assembly, providing a path for data transfer to a microprocessor housed within an inside turn assembly. A signaling device, such as an LED, is mounted in association with the assembly to indicate operational signals to the user.

### TECHNICAL FIELD

The invention relates generally to an electronic deadbolt assembly, and more particularly to an electronic deadbolt assembly including a flex assembly for making electrical connection between a power source and electrical components of a circuit board provided in association with the assembly, to a fixed data contact pin and actuating solenoid in the assembly.

### BACKGROUND OF THE INVENTION

In many environments, such as apartment houses, multi-family dwellings, condominiums or the like, the transient nature of residence present problems in using conventional locking mechanisms in association with a door having a latch which is operable from both sides of the door by means of a handle or the like. In such environments, keys usable to unlock conventional lockable latching mechanisms are easily replicated, thereby potentially comprising the security provided by the lockable latching mechanism. As tenants or occupants move from such an environment, a key or copy of the key can be retained, though the former tenant or occupant is no longer entitled to access thereto. Similarly, if maintenance or repair procedures require access by other personnel, maintaining security may again be compromised if keys are duplicated or not returned by the repair or maintenance personnel. Thus, security standards in such environments may require that the lock be removed in its entirety and replaced, or the lockable latching mechanism is swapped with other such mechanism from another unit to ensure security. Another alternative is to have the lockable latching mechanism re-keyed such that the previous key will not operate the mechanism. In each of these situations, the replacement, re-keying or swapping of the lockable latching mechanism requires expense, or presents a time consuming and inefficient process for ensuring security.

Attempts have therefore been made to provide enhanced security by providing an electronic lock which employs a programmable processor which can be programmed to only allow operation of the lock if a valid key is used. Thus, upon a tenant or occupant leaving a premises, the electronic lock can simply be reprogrammed so that the old key will not operate the lock, thereby eliminating the need to replace or re-key the lock. Although electronic locks using card readers, key pads or contact activated data ports are known, various deficiencies in such electronic lock assemblies have been found, and such systems have generally been cost prohibitive or complex, thereby limiting widespread use in such environments.

### SUMMARY OF THE INVENTION

The invention is directed to an electronic deadbolt flex assembly for transfer of data to and from microprocessor associated with the electronic lock assembly. The flex assembly comprises an electrical connector, an electrical connecting board, and at least one electrical component coupled thereto, such as a data contact spring, signaling device such as a LED and coupled to a solenoid assembly. In an embodiment of the invention, a data contact spring electrically couples a fixed data pin positioned within the cylinder plug of a lock assembly, providing a path for data transfer to a microprocessor housed within an inside turn assembly. A signaling device, such as an LED, is mounted in association with the assembly to indicate operational signals to the user. The foregoing and other aspects of the invention will become apparent from the following detailed description of the invention, when considered in conjunction with the accompanying drawings.

### BRIEF DESCRIPTION OF THE DRAWINGS

FIG. 1 is a perspective exploded schematic view showing an electronic deadbolt locking mechanism according to an embodiment of the invention;

FIG. 2 is an exploded perspective view of the flex assembly according to an embodiment of the invention;

FIG. 3 is an exploded perspective view of a solenoid assembly associated with the invention;

FIG. 4 is a perspective view of a ground clip associated with the assembly in this embodiment;

FIG. 5 is a perspective view of a data transfer spring according to this embodiment; and

FIG. 6 is an exploded perspective view of the flex connector and component attachment stiffener according to the embodiment of the invention.

### DETAILED DESCRIPTION

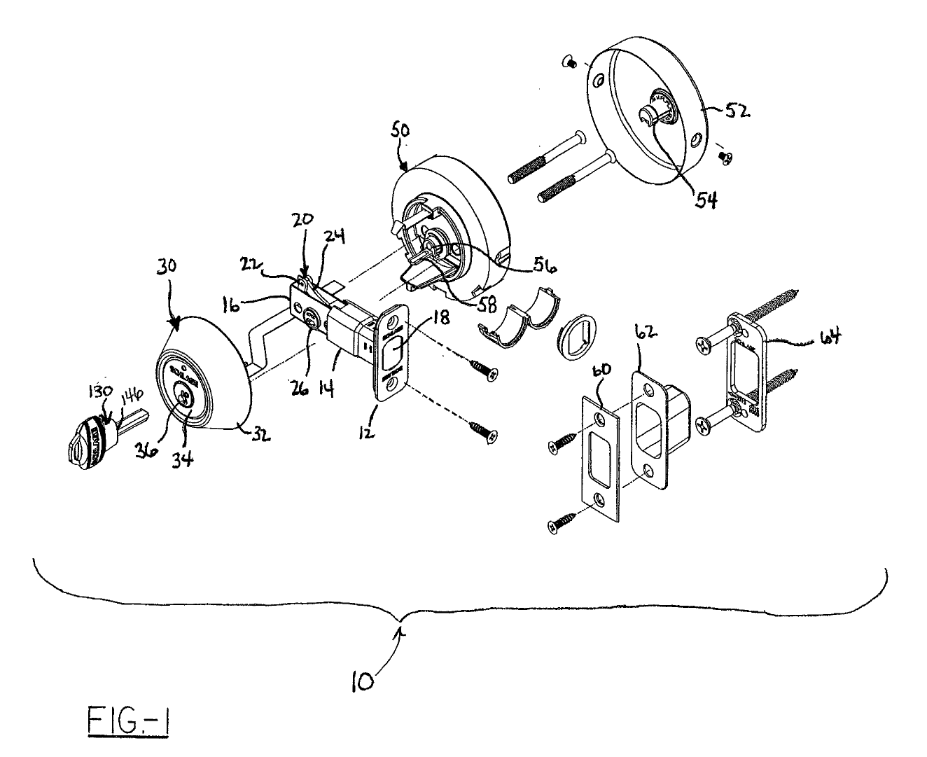

Turning now to FIG. 1, the present invention will be described in conjunction with an electronic deadbolt assembly 10. As shown in FIG. 1, the deadbolt assembly 10 may include a face plate 12, which will normally be visible from the edge of the door. A front case 14 may be joined to the front plate 12, and a rear case 16 is provided in telescopic adjustable relationship to the front case 14. A deadbolt 18 is provided in slideable relationship within the front case 14, and is coupled to a swivel generally indicated at 20. The swivel mechanism 20 may include a pair of ears 22 connected to a link 24. The link 24 is connected to the bolt 18 in a suitable fashion, and operation of the deadbolt 18 between a fully extended position and a retracted position is provided by means of a spindle 26 in a known fashion. In general, spindle 26 is engaged between inner and outer cylinders, wherein upon rotation of the cylinders, spindle 26 rotates to cause corresponding movement of the swivel 22 and link 24 and movement of bolt 18 between extended and retracted positions. The structures of the front case 14, rear case 16 and operation of the deadbolt is typical, and details of this construction and operation may be modified in accordance with known mechanisms.

The deadbolt assembly 10 as shown in FIG. 1 further comprising an outside housing assembly 30, which includes an outside rose 32 and a lock cylinder or cylinder plug 34, which will be described in more detail hereafter. The cylinder plug 34 includes a keyway 36, into which an electronic key 40 is inserted for operation of the deadbolt assembly 10. The deadbolt assembly 10 further comprises an inside turn assembly generally designated 50, over which an inside rose 52 is positioned. A thumbturn 54 is coupled to inside turn assembly 50, such that operation of the thumbturn 54 will in turn cause rotation of the thumbturn extension 54 coupled to the inside turn assembly 50, having an outwardly extending portion 58 which engages spindle 26 in the deadbolt assembly. Thus, upon rotation of the thumbturn 54 on the interior of the door, rotation of the thumbturn extension 54 will in turn cause rotation of extending portion 58 so as to operate spindle 26 causing corresponding extension or retraction of the deadbolt 18 in a known fashion. The deadbolt 18 in its extended position engages a strike 60 positioned on the door jam, and an associated strike box 62. A strike reinforcer 64 may be provided to enhance the structural integrity and security of the deadbolt latch.

It should be recognized that operation of a thumbturn in conjunction with the inside turn assembly 50 to selectively extend or retract the deadbolt 18 is generally known, and will not be described further.

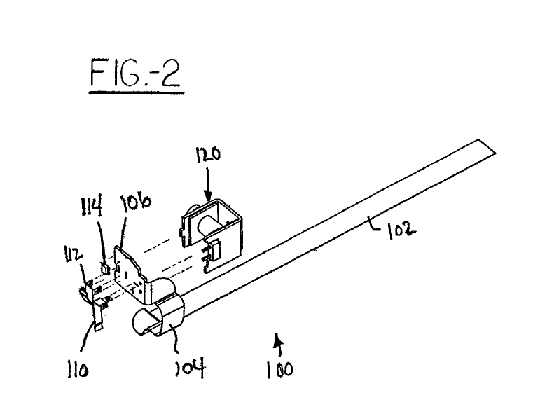

Turning now to FIG. 2, the electrical connection assembly according to the invention is shown in more detail. As seen in FIG. 2, the electrical connection assembly according to the embodiment of the invention provides various connections and components for operation of the electronic deadbolt as described with reference to FIG. 1. The assembly generally indicated at 100 includes an electrical connector or flex connector 102 which is utilized to transfer data to and from a microprocessor housed within the inside turn assembly 50. The flex 102 is thus dimensioned and configured to be fed through the electronic deadbolt assembly to be connected with the circuit board components as well as a battery power source, also housed within the inside turn assembly 50. As seen in this embodiment, the flex 102 includes an offset to facilitate positioning through other components of the lock assembly, while also providing simplified and correct attachment to the associated circuit components and power supply. In assembly, the configuration of the flex 102 promotes proper assembly while not requiring skilled labor or intricate assembly steps. Providing the electrical connection by means of a flex assembly 102, being a flexible member also facilitates assembly of the deadbolt mechanism. The flex connector 102 is electrically coupled to a formed portion 104 of the flex circuit which is configured to be installed in association with the outside turn assembly housing 30, while accommodating other components thereof. A connecting board 106 provides electrical coupling to components of the system. As seen in FIG. 6, a component attachment stiffener 108 may be provided to facilitate mounting of various components in conjunction with the flex 102, and connection board 106. As seen in FIG. 2, mounted in conjunction with the connection board 106 and associated component attachment stiffener 108, is a data transfer spring 110, a ground clip 112 and a signaling device 114, such as a multi-colored LED. Also mounted in association with the connection board 106 is the solenoid assembly 120. Each of these components is electrically coupled via the flex 102 for data transfer to or from the microprocessor associated with the electronic lock assembly, as well as operation of the signaling device 114 and/or solenoid assembly 120. Details of the electronic lock assembly are provided in U.S. application Ser. No.______, entitled Electronic Key Assembly with Spring Loaded Data Pin and Contact, filed concurrently herewith, and hereby incorporated by reference.

Turning to FIG. 3, the solenoid assembly is shown in more detail, and includes a frame 122 for housing the solenoid, the frame 122 being substantially U-shaped, and having an aperture 124 formed therein. A solenoid bobbin 126 is accommodated within frame 122 having an opening 128, which when assembled with frame 122 is aligned with aperture 124 formed in the frame 122. A solenoid plunger 130 is thereafter positioned through aperture 124 into the bobbin opening 128, into operative relationship with bobbin 126. The solenoid plunger 130 may include an enlarged head portion 132 to facilitate positioning with respect to frame 122 and bobbin 126. The solenoid plunger 130 may also include an actuator 134, to provide movement of plunger 130 with respect to bobbin 126 in a known manner. The solenoid plunger 130 is normally biased outwardly with respect to bobbin 126 by means of a bias spring blank, and upon actuation of the solenoid assembly 120 will be selectively retracted into bobbin 126. The electrical connection of the solenoid assembly 120 is provided by means of posts 136, which are coupled to the connection board 106 and associated stiffener 108.

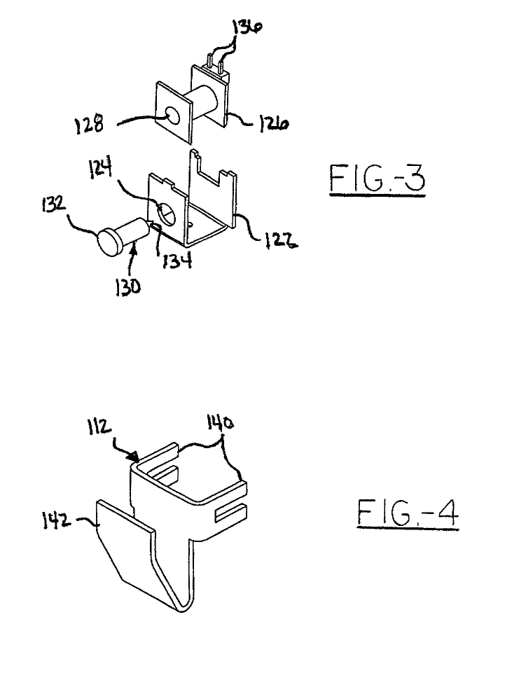

Turning now to FIG. 4, the ground clip 112 is shown in more detail, and may comprise electrically coupling posts 140 which mate to corresponding mounting holes within connection board 106 as seen in FIG. 2. The ground clip 112 may also comprise an outwardly extending clip portion 142, which is adapted to engage the outside housing 30 when the flex assembly 100 is assembled therewith. This connection to the outer housing provides electrical ground to the electrical components of the system in a desired manner.

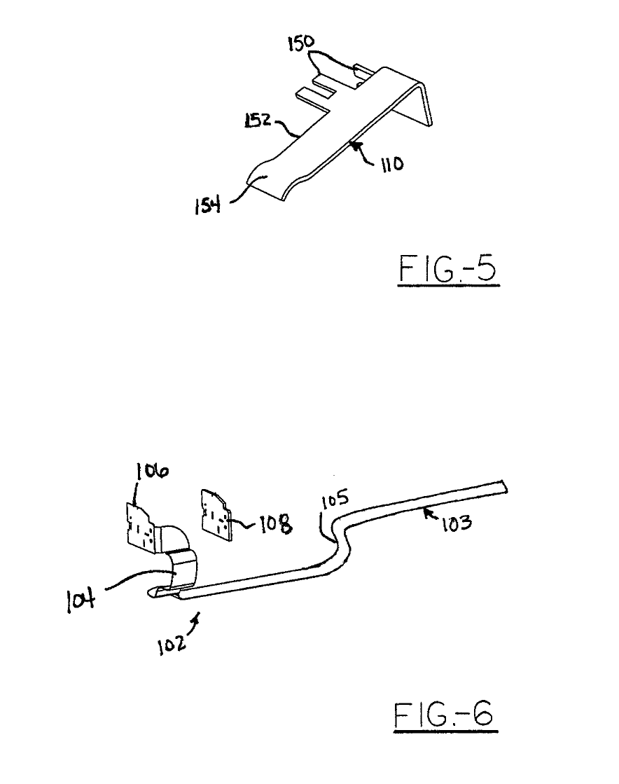

In FIG. 5, the data transfer spring 110 is shown to include electrical connecting posts or tabs 150 which mate to corresponding holes within connection board 106 as seen in FIG. 2. The data transfer spring may be substantially L-shaped, having an elongated leg portion 152 which extends downwardly when mounted in association with connection board 106. At a distal end of leg 152, an outwardly concave section 154 is provided to allow electrical contact between the data transfer spring 110 and a fixed data contact pin 35 associated with the cylinder plug 34 as described with reference to FIG. 1. When mounted in association with the connection board 106, the data transfer spring 110 extends in electrical isolation from the outside turn assembly housing 30, thus electrically isolating the connection to the data contact pin 35. In this manner, data transfer through the data contact pin 35 through the flex assembly 100 and to the microprocessor of the electronic lock assembly is provided when the cylinder plug blank is at its home position. The data transfer member 110 maintains contact with the data pin 35 until the cylinder plug 34 is rotated by a key in operation of the electronic lock.

Turning to FIG. 6, the electrical connector or flex connector 102 is shown in more detail. The connector 102 includes a flexible electrical connecting portion 103, such as a ribbon electrical connector having a plurality of conductors therein for supplying power or transferring electrical or data signals to and from electrical components in the electronic lock assembly. The flex 103 may be single or double layer or of another configuration to allow communication and transfer of data to and from electronic components of the electronic lock assembly, as well as to supply power to such components. Any other suitable or electrical connection to the electronic components is also contemplated in the present invention. As shown in Fig, 6, the electrical connector 103 may further have at least one offset 105, which may be provided to facilitate accommodating the electrical connector 103 around other components or structures in the electronic lock assembly. Based upon the connection of connector 103 to the electrical circuit board and power source, the offset 105 may also facilitate proper assembly of the connector 103 to these components. Positioning the connector 103 at a desired position relative to these components would allow unskilled assembly personnel to properly assemble and connect the components by eliminating other connection configurations and the opportunity to improperly connect the flex 103 to the electronic components.

The connector 103 is electrically coupled to bracket 104 as previously described, with the shape of bracket 104 configured to accommodate other components of the electronic lock assembly, and to make electrical connection to the solenoid assembly 120, data transfer spring 110, ground clip 112 and LED 114, or other electronic components as desired via the connecting board 106. The component attachment stiffener 108 provides additional structural integrity to the electrical connection with these or other electronic components, to provide a durable and proper functioning electronic lock assembly.

Whereas the invention has been shown and described with reference to particular embodiments thereof, it should be realized that there may be many modifications, substitutions or alterations thereto, which are encompassed within the scope of the invention. The embodiments of the invention in which an exclusive property or privilege is claimed is defined as follows.

What is claimed is:

1. An electronic lock electrical connection assembly comprising,
an electrical connector including a plurality of electrical connections for supplying power and carrying electrical signals between components of the electronic lock,
an electrical connecting board coupled to the electrical connector, and at least one electrical component operatively coupled to the connecting board.

2. The assembly according to claim 1, wherein the electrical connector is flexible to facilitate positioning around other components of the lock assembly.

3. The assembly according to claim 2, wherein the electrical connector includes at least one offset to facilitate proper assembly in association with the lock assembly.

4. The assembly according to claim 1, wherein the at least one electrical component is a solenoid assembly.

5. The assembly according to claim 1, wherein the at least one electrical component is a signaling device.

6. The assembly according to claim 5, wherein the signaling device is a LED indicator.

7. The assembly according to claim 1, wherein the electrical connector is electrically connected to a bracket mounted in association with the electrical connecting board.

8. The assembly according to claim 1, wherein a stiffener is provided in conjunction with the electrical connecting board to provide additional structural integrity thereto.

9. The assembly according to claim 1, wherein a grounding member is connected to the electrical connecting board and extends therefrom to contact another portion of the lock, thereby forming an electrical ground for the at least one electrical component.

10. The assembly according to claim, wherein a data transfer member is coupled to the connecting board and extends therefrom into electrical contact with a data pin of the electronic lock, providing a path for electrical signals from the data pin to a microprocessor programmed to control operation of the electronic lock.

11. The assembly according to claim 10, wherein the data transfer member maintains contact with the data pin until a cylinder of the electronic lock is rotated by a key in operation of the electronic lock.

12. An electric lock assembly comprising,
a lock cylinder rotatably mounted in conjunction with a locking mechanism, with selective rotation of the lock cylinder causing unlocking of the locking mechanism, the lock cylinder being selectively prevented from rotation by means of a solenoid assembly controlled electronically,
an electrical connector for supplying power to the solenoid assembly from a power source housed within the lock assembly, the solenoid assembly being coupled to the electrical connector through an electrically connecting board to which the solenoid assembly is mounted.
